(19) United States
(12) Patent Application Publication
(10) Pub. No.: US 2003/0103193 A1
(43) Pub. Date: Jun. 5, 2003

(54) Use of resonant microcavity display FED for the illumination of a light valve projector

(76) Inventors: Eugene Murphy O'Donnell, Fishers, IN (US); Estill Thone Hall JR., Fishers, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/007,157

(22) Filed: Dec. 5, 2001

(51) Int. Cl. G03B 21/00

(52) U.S. Cl. 353/31

(57) ABSTRACT

An illumination source for a LCOS projection system, is comprised of a vacuum cavity, an array of field emission display points on a first side of the vacuum cavity, and an array of resonant microcavity anodes on a second side of the vacuum cavity. The field emission display points are electron emitters used to excite array of resonant microcavity anodes to exclusively generate light of a selected color. The light is projected through an LCOS device to produce an image. A projector lens is provided for magnifying and focusing the image for projection on a screen.

### BACKGROUND OF THE INVENTION

1. Field of the Invention

The present invention concerns projection displays and more particularly improvements in the illumination system for such displays.

2. Description of Related Art

Liquid crystal on silicon (LCOS) can be thought of an as one large liquid crystal formed on a silicon wafer. The silicon wafer is divided into an incremental array of tiny plate electrodes. A tiny incremental region of the liquid crystal is influenced by the electric field generated by each tiny plate and common electrode. Each such tiny plate and corresponding liquid crystal region are together referred to as a cell of the imager. Each cell corresponds to an individually controllable pixel. Each set of common and variable plate electrodes forms an image

The light supplied to the LCOS imager, and therefore supplied to each cell of the imager, is field polarized. Each liquid crystal cell rotates the polarization of the input light responsive to the root mean square (RMS) value of the electric field applied to the cell by the plate electrodes.

There are many techniques that can be used to create projection engines utilizing LCOS imagers. One method is to apply a digital signal to the imager so as to arrange the pixels in a configuration to form the image. In order to form the image, light from a light source passes through the pixels defined by the imager and bounces off a reflective surface of the opposing side. The reflected light exits the imager in the direction from which it originated. The reflected light goes through a lens that magnifies and focuses the image onto a screen.

An LCOS imager can be used to create a color display using a combination of three imagers. One method of creating such a color display makes use of a series of prisms that together form a cube. As the light enters the cube it is split into three beams, one of which is directed towards each of the three imagers. Each of the displays has a red, green or blue filter associated with it so that only one color is sent to each imager. Each imager is then driven with a digital signal associated with the correct image for its corresponding color. The red, green and blue light passes through a respective one of the imagers and is then reflected back through the imager by a reflecting surface. The imager selectively changes the polarization of light passing through certain cells and such light is then either passed or blocked using an appropriate polarizing filter. The light that is allowed to pass forms an image. The images generated for each respective color are combined in the cube to create the final color image to be projected.

Currently, one of the major issues with projection displays such as LCOS is the lack of an adequate light source for illumination. The existing technology is inefficient, short lived, and requires major optical systems to transform the light into a usable form. The most common current solution to the foregoing problem is the high-pressure arc lamp. The high-pressure arc lamp has become the industry standard primarily because it is the only such lamp to have a reasonable lifetime. For example, a typical high-pressure arc lamp can average 10,000 hours.

Despite the advantages offered by the high-pressure arc lamp, they also possess a number of negative attributes. For example, they require a very small arc to make a sensible etendue (the product of radiant flux density and the area of a radiating or receiving surface). This implies a reduced lifetime for the light source and generally requires that the lamp bulb must be replaced several times over the life of the projection display.

Another significant disadvantage of the high-pressure arc lamp concerns the nature of the output produced. In particular, these light sources are inherently broadband in terms of spectral output. This means that in addition to primary color light (red, green, blue) that is useful for projection, the generated output will also contain unwanted components in the visible spectrum, as well as infrared and ultraviolet components. The inefficiencies of color filters used to process this light can also lead to broader band colors and therefore a smaller color space.

A further issue concerns the random or mixed polarization produced by high-pressure arc lamps. Non-CRT projection displays such as LCOS commonly require particular polarizations and it is therefore necessary to provide optical system components to be provided for polarization separation. Similarly, since the light coming from the lamps is essentially white, it is necessary to provide dedicated dichroic filters necessary to produce red, green, and blue light. In order to enhance the etendue, complex systems of integrators and collimators are also required to transform a focused beam into a uniform rectangular illumination. These additional components naturally increase the cost and complexity of such displays. They also increase the size and weight of the optical display. Finally, the wasted light energy inherent in such systems increases the heat generated by the projection system.

In attempt to reduce the cost and complexity of such systems and improve image quality, it is desirable to provide a system that will avoid the problems of the prior art. Accordingly, there is a need in the art for a light source for non-CRT displays that generates less heat than existing systems that employ a high pressure arc lamp. There is a further need in the art for such a system in which the optical system is compact, highly reliable, and without the need for complicated light transmission paths.

Microcavity resonators, which can be incorporated in the present invention, have existed for some time. Microcavities are one example of a general structure that has the unique ability to control the decay rate, the directional characteristics and the frequency characteristics of luminescence centers located within them. The changes in the optical behavior of the luminescence centers involve modification of the fundamental mechanisms of spontaneous and stimulated emission. Physically, such structures as microcavities are optical resonant cavities with dimensions ranging from less than one wavelength of light up to tens of wavelengths. These have been typically formed as one integrated structure using thin-film technology. Microcavities involving planar, as well as hemispherical, reflectors have been constructed for laser applications.

The resonant microcavity display or resonant microcavity anode (RMA) is more fully described in U.S. Pat. Nos. 5,469,018 (to Jacobsen et. al), 5,804,919 (to Jacobsen et al), and 6,198,211 (to Jaffe et al), and in an article written by Jaffe et al entitled “Avionic Applications of Resonant Microcavity Anodes”, all hereby incorporated by reference. The controlled light output of an RMA utilizes a thin film phosphor inside a Fabry-Perot resonator. The structure of a monochrome RMA can consist of a faceplate having a thin film phosphor embedded inside a resonant microcavity. The references mentioned above clearly describe the benefits of using an RMA arrangement over a conventional CRT or FED arrangement using phosphor powders.

### BRIEF SUMMARY OF THE INVENTION

The invention concerns an illumination source for a LCOS projection system. The illumination source is comprised of a vacuum cavity, an array of field emission display points on a first side of the vacuum cavity, and an array of resonant microcavity anodes on a second side of the vacuum cavity. The field emission display points are electron emitters used to excite array of resonant microcavity anodes to exclusively generate light of a selected color.

According to one embodiment, the resonant microcavity anodes can be arranged so that the light is projected through an LCOS device to produce an image. A projector lens can also be provided for magnifying and focusing the image for projection on a screen.

The invention also lends itself to a method for displaying an image. The method can include the steps of exciting the array of resonant microcavities for exclusively emitting light of the selected color and projecting the light through an LCOS imager defining a plurality of controllable pixels to produce an image. The image can be magnified and focused using a lens so that the image can be more readily projected on a screen. The method can also include optically combining the image produced with the light of the selected color with at least one other image of a second selected color distinct from the first selected color. In that case, the colors for the illumination source can be advantageously selected from the group consisting of red, green and blue to produce a full color picture.

According to alternative aspect, the invention can comprise a projection type display unit. The display unit includes an imager, such as an LCOS device, having an array of controllable pixels. The unit also includes a light source for exclusively generating light of a selected color. The light source can be arranged for transmitting the light through the imager to produce an image that can be projected through a lens for magnifying and focusing the image. The light source is advantageously comprised of a field emission device exciting a resonant microcavity with an active region. The active region has a phosphor disposed therein for emitting light.

According to a preferred embodiment of the projection display unit, three imagers and three field emission devices can be provided. In that case, each of the field emission devices exclusively generates a distinct color of light for projection through a respective one of the imagers to produce three distinct color images. For example, the three field emission devices can produce red, green and blue light respectively. The system can also include an optical combiner for merging together each of the distinct color images to form a single composite image.

### BRIEF DESCRIPTION OF THE DRAWINGS

FIG. 1 is a drawing useful for illustrating the concept of a resonant microcavity type field emission display.

FIG. 2 is a block diagram useful for illustrating how a resonant microcavity type field emission display can be used as an illumination source for an LCOS display.

### DETAILED DESCRIPTION OF THE PREFERRED EMBODIMENTS

A field emission display (FED) is a type of flat-panel display in which electron emitters, arranged in a grid, are individually controlled by “cold” cathodes to generate colored light. Conventional FED devices are commercially available from a variety of companies, including Candescent Technologies Corporation of 6320 San Ignacio Ave, San Jose, Calif. 95119.

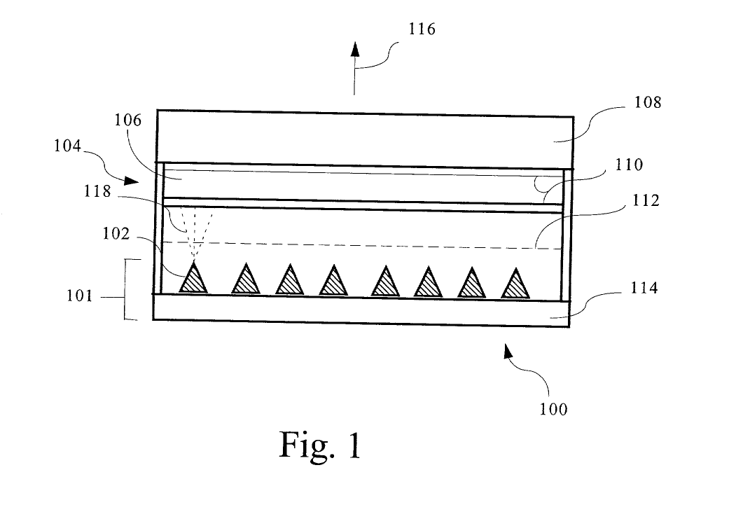

FIG. 1 is a diagram useful for understanding the operation of a resonant microcavity anode (RMA) type FED device 100 which can be used with the present invention. The FED device 100 is comprised of a cathode 101 formed from an emitter array 102 that is positioned on a silicon substrate 114. An RMA type anode 104 is spaced apart from the cathode and positioned behind glass 108. The anode is preferably comprised of a thin film phosphor 106 which can be formed between dielectric mirrors 110. As electrons 118 excite the thin film phosphor 106 causing the emission of light through glass 108 in the direction of arrow 116. A control grid may also be provided for modulating the intensity of the electrons 118 directed toward anode 104

The use of resonant microcavity anodes in an FED display is known. For example, the resonant microcavity display or resonant microcavity anode (RMA) is more fully described in U.S. Pat. Nos. 5,469,018 (to Jacobsen et. al), 5,804,919 (to Jacobsen et al), and 6,198,211 (to Jaffe et al), and in an article written by Jaffe et al entitled “Avionic Applications of Resonant Microcavity Anodes”, all hereby incorporated by reference. However, FED type displays have generally been used in applications to directly produce an image using the individually controllable emitters comprising the emitter array. By comparison, the present invention makes use of an RMA type FED to provide a light source of selected wavelength having relatively high intensity and good spectral purity. In particular, the present invention makes use of the RMA type FED in an LCOS type display as shall hereinafter be described in greater detail.

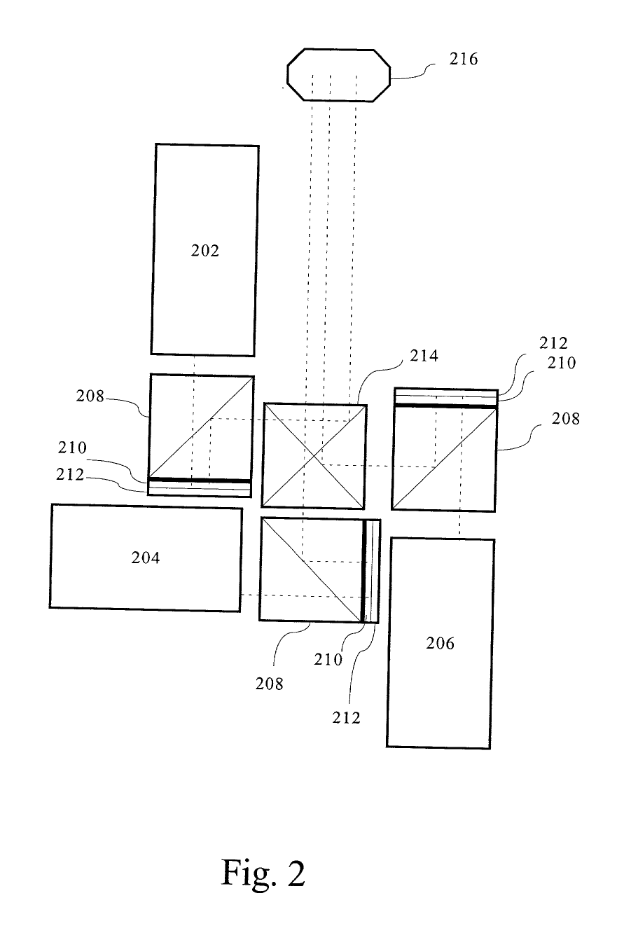

FIG. 2 is a block diagram useful for illustrating the present invention. The invention is different from conventional LCOS displays that make use of high pressure arc lamps combined with color filters to produce light for an LCOS display. Instead, one or more RMA type FEDs 202, 204, 206 are arranged to directly produce light of a selected wavelenth and intensity. For example, in a preferred embodiment, each of the FEDs can be selected to produce one of either red, green and blue light. Light produced by FEDs 202, 204, 206 passes through an associated polarizing beam splitter 208 provided for each FED. Light passing through each of the polarizing beam splitters 208 is passed through a quarter wave plate 210 and through a respective LCOS imager to form an image. The light is reflected back through the LCOS imager 212 and is reflected as shown in each case by the polarizing beam splitter 208, toward the conventional crossed dichroic combiner 214. The crossed dichroic combiner combines the reflected images and directs them toward a projection lens 216.

The RMA type FED illumination source provides several significant advantages. The FED units have considerably more useful life as compared to the high-pressure arc lamps and they also generate less heat. Also, the present approach avoids the need for color filters for separating the illumination provided by the high-pressure arc lamp into red green and blue. Finally, the light produced by the RMA type FED is of higher spectral purity as compared to that achievable using conventional color filtering techniques. This produces a considerably larger color space when using the FED approach as described herein.

What is claimed is:

1. A projection type display unit, comprising,
an imager defining a plurality of controllable pixels;
a light source for exclusively generating light of a selected color, said light source arranged for transmitting said light through said imager to produce an image; and
a projector lens for magnifying and focusing said image for projection on a screen;
wherein said light source is comprised of a field emission device exciting a resonant microcavity anode with an active region, said active region having a phosphor disposed therein for emitting light of said selected color.

2. The projection display unit according to claim 1 wherein said imager is an LCOS device.

3. The projection display unit according to claim 1 wherein three said imagers are provided and three said field emission devices are provided, each of said field emission devices exclusively generating a distinct color of light for projection through a respective one of said imagers to produce three distinct color images.

4. The projection display unit according to claim 3 wherein said three field emission devices produce red, green and blue light respectively.

5. The projection display unit according to claim 4 further comprising an optical combiner, said optical combiner merging each of said distinct color images to form a single composite image.

6. An illumination source for a LCOS projection system, comprising:
a vacuum cavity;
an array of field emission display points on a first side of the vacuum cavity;
an array of resonant microcavity anodes on a second side of the vacuum cavity for generating light of a selected color;
wherein said field emission display points are electron emitters used to excite array of resonant microcavity anodes to exclusively generate light of said selected color.

7. The illumination source according to claim 6 wherein said array of resonant microcavity anodes is arranged so that said light is projected through an LCOS device to produce an image.

8. The illumination source according to claim 7 further comprising a projector lens for magnifying and focusing said image for projection on a screen.

9. A method for displaying an image, comprising,
exciting an array of resonant microcavities configured for exclusively emitting light of a selected color;
projecting said light through an LCOS imager defining a plurality of controllable pixels to produce an image; and
magnifying and focusing said image through a lens for projection on a screen.

10. The method according to claim 9 further comprising the steps of:
optically combining said image produced with said light of said selected color with at least one other image of a second selected color distinct from said first selected color.

11. The method according to claim 10 wherein said colors are selected from the group consisting of red, green and blue.
